(19) United States
(12) Patent Application Publication
(10) Pub. No.: US 2003/0074252 A1
(43) Pub. Date: Apr. 17, 2003

(54) System and method for determining internet advertising strategy

(75) Inventors: John Chandler-Pepelnjak, Missoula, MT (US); Aaron Easterly, Seattle, WA (US)

Correspondence Address: BENNET K. LANGLOTZ, BOX 759, GENOA, NV, 89411, US

(73) Assignee: Avenue A, Inc.

(21) Appl. No.: 09/976,742

(22) Filed: Oct. 12, 2001

(51) Int. Cl. G06F 17/60

(52) U.S. Cl. 705/10

(57) ABSTRACT

A method of predicting the performance of an Internet advertising campaign includes collecting anonymous web-surfing data during the serving of past Internet advertisements to determine the number of impressions served to each user visiting a selected site during a selected interval. The users are grouped into subgroups based on the percentage of impressions served to each subgroup. The service of a selected number of advertisements is simulated by randomly assigning each simulated advertisement to a user based on the number of impressions served. A projected reach value is calculated by determining the number of users to which at least a selected number of simulated advertisements were served.

### FIELD OF THE INVENTION

This invention relates to internet communication, and more particularly to commercial and advertising analysis.

### BACKGROUND AND SUMMARY OF THE INVENTION

In conventional advertising, it has often proven important to be able to estimate the “reach” of an advertising campaign or effort, which represents the number of people who will be reached by the campaign. This applies whether the advertisement is in the print media, on broadcast, on a billboard, or any other medium. Advertising agencies seek to assist advertisers who are investing in advertising campaigns to maximize the effect of their investment. A campaign typically involves several different media outlets, whether or not within the same type of media. An advertiser generally wishes to know how many people will be reached via each outlet, and at what cost per person reached.

Traditional advertising efforts generally seek to quantify and measure audience. A common measure of advertising exposure to a target group is Gross Rating Points (GRPs). A GRP is defined as Reach (the total number of users exposed to an advertisement) times Frequency (the average numbers of times each user is exposed) for a given advertisement placement or “buy.” Targeted Rating Points (TRPs) are very similar, referring to GRPs for a targeted subgroup, such as a limited age range, gender, geographic region, income, or subcombination of these or other demographic categories. When planning campaigns, traditional marketers also use the concept of Effective Reach, which is the size of audience reached at a particular frequency (e.g. 100,000 viewers have viewed an advertisement at least three times.)

Advertising on the Internet may employ similar principles. To determine the number and demographics of users of a website on which advertisements may be placed, research entities (analogous to television ratings services) collect such data. This enables advertisers (or agencies working on their behalf) to determine how many potential users may be reached on each site under consideration. Prospective advertising campaigns can be evaluated based on data from past campaigns. During a past campaign, for example, 100,000 advertising “impressions” on a particular web site may have been served. When each was served, a “cookie” or unique identifier associated with the user's computer or other communication device is collected. The data regarding the collected cookies is then analyzed to determine how many different users were served. The number of users is less than the number of ads served, due to some more frequent users receiving more than one advertisement.

This analysis provides an estimate useful for comparison, although it discounts that some users may use different devices (thus appearing in the calculation as different cookies), while some duplicate cookies may be due to different users sharing a common device. Sites vary widely in their duplication characteristics. At some sites, a relatively large portion of impressions are viewed by a small minority of dominant users, with the remaining bulk of users being only rare occasional users; at other sites, user activity levels are relatively equal among the users.

By analyzing the past campaign, an estimate may be made about a prospective campaign. For instance, if 100,000 advertisement impressions served turned out to have reached 50,000 users on a given site, one might estimate that this yield would apply to other campaigns, even though those campaigns occur at different times, are of different sizes, and are targeting different demographic subgroups. A campaign that hopes to reach 100,000 males between ages 16 and 24 based on this data might roughly assume that if such people make up 10% of the site's users, then 1,000,000 users must be reached, requiring 2,000,000 impressions to be served based on the past history of duplication.

However, basing future assumptions on one snapshot has limitations, and is subject to errors. Errors that overstate the reach of a campaign undermine the credibility of the person making the estimate. Errors that understate the reach lead to over-investment in advertising, purchasing more impressions that were needed to meet marketing goals.

Other disadvantages of the snapshot approach, include the difficulty of factoring in the rate of impressions served. A campaign that shows 100,000 impressions in a day can expect to reach fewer users than a campaign that spreads those impressions out over several weeks. The significance of the factor of rate of impressions is difficult to gauge in a with the snapshot approach.

Additionally, the large number of cookies that are set on browsers that do not accept cookies can lead to dramatic errors in correlating users with cookies. This limitation can create reach estimates that are too high by an order of magnitude.

The present invention overcomes the limitations of the prior art by providing a method of predicting the performance of an Internet advertising campaign by collecting anonymous web-surfing data during the serving of past Internet advertisements to determine the number of impressions served to each user visiting a selected site during a selected interval. The users are grouped into subgroups based on the percentage of impressions served to each subgroup. The service of a selected number of advertisements is simulated by randomly assigning each simulated advertisement to a user based on the number of impressions served. A projected reach value is calculated by determining the number of users to which at least a selected number of simulated advertisements were served.

### BRIEF DESCRIPTION OF THE DRAWINGS

FIG. 1 is a schematic block diagram showing the system according to a preferred embodiment of the invention.

FIG. 2 is a flow chart showing the method of operation according to the preferred embodiment of the invention.

### DETAILED DESCRIPTION OF A PREFERRED EMBODIMENT

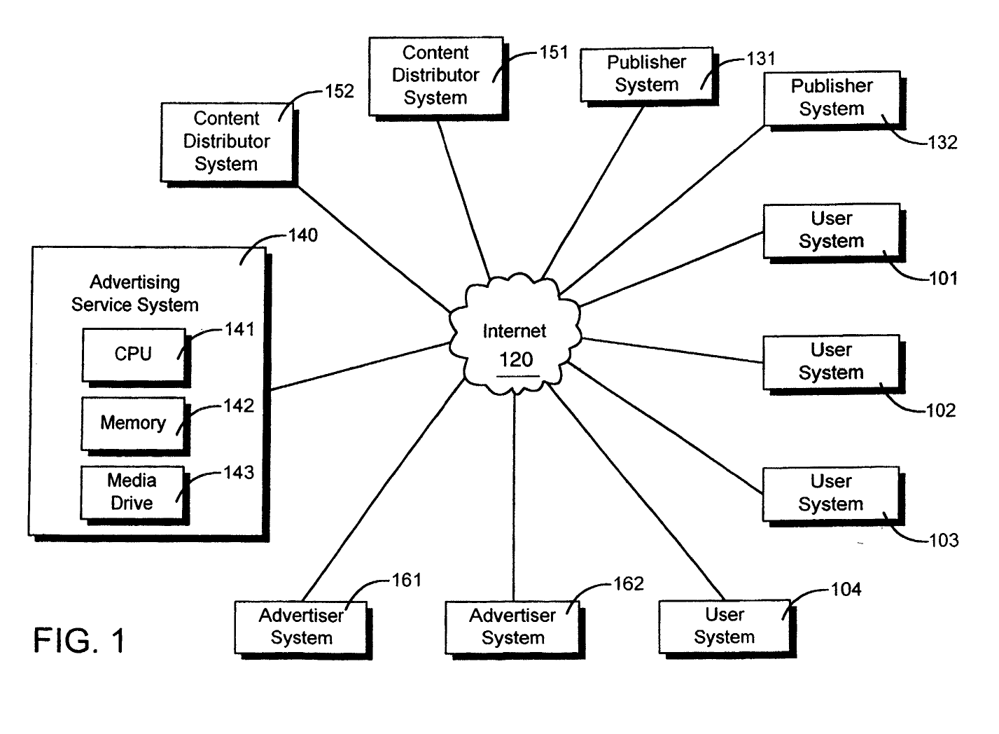

FIG. 1 is a high-level block diagram showing the environment in which the facility preferably operates. The diagram shows a number of Internet customer or user computer systems 101-104. An Internet customer preferably uses one such Internet customer computer system to connect, via the Internet 120, to an Internet publisher computer system, such as Internet publisher computer systems 131 and 132, to retrieve and display a Web page. Although discussed in terms of the Internet, this disclosure and the claims that follow use the term “Internet” to include not just personal computers, but all other electronic devices having the capability to interface with the Internet or other computer networks, including portable computers, telephones, televisions, appliances, electronic kiosks, and personal data assistants, whether connected by telephone, cable, optical means, or other wired or wireless modes including but not limited to cellular, satellite, and other long and short range modes for communication over long distances or within limited areas and facilities.

In cases where an Internet advertiser, through the Internet advertising service company, has purchased advertising space on the Web page provided to the Internet customer computer system by the Internet publisher computer system, the Web page contains a reference to a URL in the domain of the Internet advertising service company computer system 140. When a customer computer system receives a Web page that contains such a reference, the Internet customer computer systems sends a request to the Internet advertising service computer system to return data comprising an advertising message, such as a banner advertising message. When the Internet advertising service computer system receives such a request, it selects an advertising message to transmit to the Internet customer computer system in response the request, and either itself transmits the selected advertising message or redirects the request containing an identification of the selected advertising message to an Internet content distributor computer system, such as Internet content distributor computer systems 151 and 152. When the Internet customer computer system receives the selected advertising message, the Internet customer computer system displays it within the Web page. The Internet advertising service is not limited to banner advertisement, which are used as an example. Other Internet advertising modes include email messages directed to a user who has provided his or her email address in a request for such messages.

The displayed advertising message preferably includes one or more links to Web pages of the Internet advertiser's Web site. When the Internet customer selects one of these links in the advertising message, the Internet customer computer system de-references the link to retrieve the Web page from the appropriate Internet advertiser computer system, such as Internet advertiser computer system 161 or 162. In visiting the Internet advertiser's Web site, the Internet customer may traverse several pages, and may take such actions as purchasing an item or bidding in an auction. The Internet advertising service computer system 140 preferably includes one or more central processing units (CPUs) 141 for executing computer programs such as the facility, a computer memory 142 for storing programs and data, and a computer-readable media drive 143, such as a CD-ROM drive, for reading programs and data stored on a computer-readable medium.

While preferred embodiments are described in terms of the environment described above, those skilled in the art will appreciate that the facility may be implemented in a variety of other environments, including a single, monolithic computer system, as well as various other combinations of computer systems or similar devices.

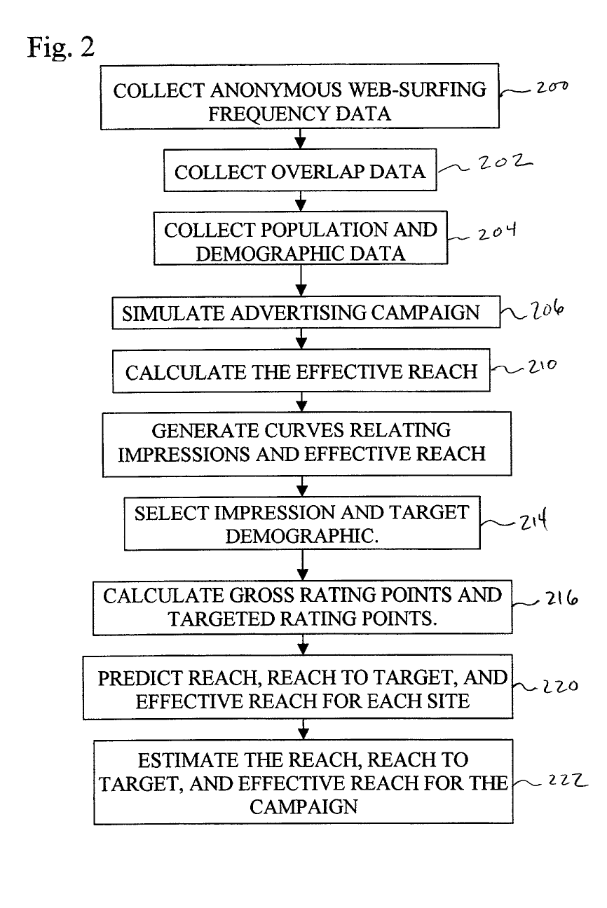

FIG. 2 shows a process flow for the predictive assessment of an Internet advertisement according to a preferred embodiment of the invention. The process is intended to provide improved accuracy in predicting Gross Ratings Points (=100×number of impressions/total population), Reach (percentage of total users who are served an advertisement), and Frequency (the number of advertisements served to a selected or average user.)

The activity discussed herein is largely conducted by the advertising service company, but many of the process steps to be discussed below may be performed by the client/advertiser, or their in-house advertising company. Tools, such as software and equipment programmed to generate the process detailed below, may be used by any of the entities, or combinations of them. The tools may be internal to the Advertising Service Company, to generate results transmitted to clients, or the tools may be created for interactive use by the clients.

The process begins by the collection of several types of data. As shown in FIG. 2, in step 200, the Advertising Service Company 140 collects anonymous web-surfing frequency data. “Frequency” is simply the number of impressions a user receives, and the frequencies for a population will be distributed differently for different sites and different other circumstances. Data collection occurs over the normal course of serving advertisements on the various Publisher web sites that are contemplated for future advertising campaigns. Data collection entails recording the impressions of each cookie. This is used to generate a database, which is analyzed as discussed below to establish what number of impressions are received by each user. This will quantifiably differentiate those sites where a small fraction of users receive a large share of impressions, from those other sites where impressions are relatively evenly distributed. The frequency data is instrumental in establishing how many impressions are required to reach a selected number of users.

In step 202, an optional data collection step may occur to further refine and improve the accuracy of the resulting predictions. The Advertising Service Company, in collecting cookie data for each of the several candidate publisher sites, generates a database of cookies that not only may be used to determine duplication of advertising impressions for a given cookie at a given site, as in step 200, but which also may be used to determine the degree of overlap between sites. For each site, each cookie is checked against the cookie lists for other sites to determine if that cookie was also served an advertisement on another site during the same test interval. The percentage of cookies that were served only on the first site in question is calculated, as is the percentage that were served on both the first site and each other site. For example, it may be determined that there is a 2% overlap between site A and site B, 3% overlap between site A and site C, and 5% overlap between site A and site D, with 90% of cookies visiting only site A. Thus, if a future campaign proposes to use sites A, B, and C (but not D), the projected reach from site A may be discounted by 5%, because 5% of users will have been reached on those other sites. In practical terms, the discount may effectively be one half of the projected overlap, since the same calculation for each of sites B and C, will properly compensate for the other half of the overlap users.

Step 204 entails the collection of data providing population size and demographic information on the various Internet sites under consideration for the advertising campaign. This is normally conducted by an outside Rating firm not shown in FIG. 1, analogous to the firms that estimate television viewership. The population information collected indicates the total number of “hits” or potential impressions the site can generate in a given time period. Essentially, this measures the size of the advertiser's audience. Demographic information is also collected about the advertiser's audience. Because web users are anonymous, demographic information is collected through surveys and other conventional research tools, as with broadcast media ratings services. Demographic information may include age, sex, income, parental status, and geographic location, for instance.

The above information may be collected in any order, without one step being dependent on the next as illustrated. Once the information is collected, an advertising campaign is statistically simulated. Using the frequency distributions, the Monte Carlo method is preferably used to simulate a buy of a certain impression level on each of several selected sites.

The simulation proceeds for each site by segregating the users (i.e., cookies) recorded to have visited that site into groups, to generate “buckets” or “bins” of users. The users are sorted based on what the frequency data indicates is the expected number of impressions they have received in the past, with the most active users in the top decile, and the least active users in the bottom decile. A simplified example of this follows, in which the total user population is 100 cookies, and 1000 advertisements are to be served in the simulation:

| | Bin | % of | Cumulative | # of ads | |
|---|---|---|---|---|---|
| Cookie | popula- | impressions | % of | allo- | Ad ID |
| numbers | tion | served | impressions | cated | numbers |
| 1-10 | 10 | 50 | 50 | 500 | 1-500 |
| 11-20 | 10 | 25 | 75 | 250 | 501-750 |
| 21-30 | 10 | 15 | 90 | 150 | 751-900 |
| 31-40 | 10 | 5 | 95 | 50 | 901-950 |
| 41-50 | 10 | 2 | 97 | 20 | 951-970 |
| 51-60 | 10 | 1 | 98 | 10 | 971-980 |
| 61-70 | 10 | ..8 | 98.8 | 8 | 980-988 |
| 71-80 | 10 | .06 | 99.4 | 6 | 988-994 |
| 81-90 | 10 | .04 | 99.8 | 4 | 994-998 |
| 91-100 | 10 | .02 | 100 | 2 | 998-1000 |

To run the simulation, each of 1000 advertisements are “served”. First, the advertisement is assigned a random number in the range of the total number of ads (1-1000). Second, based on that number, it is assigned to the bin in which that ID number is found (e.g. if the ad is assigned number 635, it is assigned to the second bin associated with cookies 11-20.) Thus, the ad will be assigned to one of the cookies within that bin. Third, the ad is assigned to one of the cookie-members of the assigned bin by random choice. This proceeds with each of the advertisements simulated. After this, each cookie has been reached with a given number of advertisements, which is recorded and stored.

Those in each bin will likely have different numbers of ads assigned, as the randomizing effects creates a statistical distribution within each bin. Some members of lower bins may receive more ads than some members of relatively higher bins. However, because this randomizing effect is based on actual probabilities, and not simple statistical noise, a smoother and more useful distribution will be achieved in the result, which will show that a certain number received zero ads, another number received one ad, another number received two, etc. For each integer number of ads that may have been served, a certain number of the cookies received that number. This data may usefully be converted into a simpler form, by stating that x percent of cookies received an advertisement, or y percent were reached by at least n advertisements. Alternatively, a useful form of to display the results in what is known as a frequency histogram. This is a summary table indicating how many cookies received n impressions, for every integer n up to a certain point.

This is preferable to a non-randomized scheme, in which the advertisements are presumed smoothly distribute (with exactly 5 ads being served to each of cookies 1-10, for instance, and exactly 2.5 to each of cookies 11-20.) This creates a stepped, discontinuous result, that introduces thresholds that do not exist in reality, in addition to the problem of fractional ads. The chief limitation of the completely deterministic process is that the frequency histogram is not smooth. This lack of smoothness becomes a problem when one wishes to view Effective Reach for consecutive frequencies. A small change in frequency (say from 2 to 3) can produce a sharp change in the number of cookies. This contradicts the behavior observed empirically in actual campaigns where the frequency histogram describes a smooth curve (over the discrete set of integers). The disclosed method of prediction much more closely predicts eventual results than do prior methods.

A potential drawback for the Monte Carlo bucketing method is that it can be computationally costly to run. In particular, an application that sat on a users desktop could take a prohibitively long time to accomplish the estimation. Therefore, an additional technique must be used to process the output of the Monte Carlo method. For every Site and for Effective Frequencies from 1 to 15, the Effective Reach for many impression levels is calculated. For each frequency level, a series of points are produced. these points describe the interplay between reach and impressions under the Monte Carlo method. Moreover, these points describe a smooth curve. One may fit curves that describe the relationship between Impressions and Effective Reach for each of the effective frequencies from 1 to 15. This process can be run intermittently, then those curves can be evaluated by the application in real time to produce frequency estimates.

Having converted the recorded frequency data into a useful form, the impression levels for a proposed Media Plan may then be input in step 214, and converted into the desired information. The information may be input directly by the advertiser, or by the Advertising Service Company assisting in planning the buy. In addition, a target demographic may also be input in step 214.

The Gross Ratings Points (GRP) for this buy are calculated in step 216. For each site, the number of impressions to be delivered is divided by the total population, with the resulting ratio multiplied by 100. A GRP of 100 means that as many impressions were purchased as there are users to be reached. The sum of the GRP numbers for each site in the campaign yields the total GRP for the campaign. A Target Rating Point (TRP) number is calculated for each site, based on the GRP, multiplied by the percentage of the site's population in the targeted demographic group.

To determine the reach, for each site, as in step 220, the above simulation-derived curves are used to predict the number of users that will receive at least one advertisement. To predict the target reach, the reach is multiplied by the percentage of the site user population believed to be in the targeted demographic. For instance, an advertiser may wish to know the number of people ages 16-24 that will be reached with at least one advertisement each by purchasing 100,000 impressions at a selected site. The demographic data collected at step 204 may show that 40% of the site's users are in this group. The simulated campaign at step 206 shows that a given number of impressions will reach perhaps 20,000 users because of extra ads “consumed” by the more active users. Thus, multiplying these together, the targeted reach will be 8,000 users in the targeted demographic. To determine the effective reach for a pre-determined frequency, the simulated campaign data is used to predict the number of users who received at least the pre-determined number of impressions. This calculation is the same as the reach calculation, except that the effective frequency is a number greater than one.

This is the process for determining the reach numbers for a single site. Because an advertising campaign generally uses multiple sites, step 222 is used to calculate the reach, reach to target, and effective reach of the entire campaign across all selected publisher web sites. In a simple embodiment, the reach figures as calculated in step 220 are summed for all sites, yielding a campaign reach. Similarly, the targeted reach and effective reach may also be summed. For more accurate campaign reach figures, however, it is preferable to account for duplication among sites, so that a user reached at one site is not doubly counted when he receives another impression at another site. This may be accounted for by the methods discussed above. Another simple alternative approach to account for duplication is to assume that duplication occurs randomly. This is to say that the population of users at each site are presumed randomly drawn from the population at large, so that the proportion of a first sites users who are also users of a second site is that same as the ratio of the second site's population to the population at large. Thus, when two sites each have 10% of the total population, 1% of the population is presumed to be a member of both site's population, yielding a total of only 19% of the population in either of both sites. The formula for this may be expressed as:

Combined reach=1−[(1−ReachA)×(1−ReachB)×(1-ReachC)]

Where ReachA, ReachB, and ReachC are the reach percentages for each of the sites.

The above techniques are useful to compare sites that saturate quickly with a given amount of ads because of a relatively small user base. At such sites, the law of diminishing returns dictates that serving enough impressions to reach the least frequent users may result in unproductive duplication of impressions served to the more active users. Large sites, on the other hand, represent more fertile opportunities to reach new users with a given set of impressions, even after many impressions have been served. While it may seem advantageous to use large sites and avoid smaller sites, this is not necessary with the above analysis tools. Thus, the tools allow advertisers to find relatively affordable impressions to be served on smaller sites, with the tools helping to avoid over-saturation of such sites. Moreover, the smaller sites may have particularly distinct demographic characteristics that make them useful to an advertiser with a narrowly focused targeted demographic.

Similarly, the above process allows the distinction not just between different size sites but between sites with different user activity characteristics. Some sites have relatively uniform users surfing patterns, where there is little difference between the more active and less active users. A site offering weather forecasts is an example of this, since most users arrive to collect essentially the same information. On the other hand, a financial site might have very different types of user surfing patterns, with many users simply visiting for a quick stock quote, but others conducting extensive research. This latter type of site is troublesome for advertisers without the above tools. However, the above process allows planners to determine an appropriate impression level to arrange, which does not cause excessive inefficient saturation, but which does not leave cost effective opportunities unexploited.

While the above is discussed in terms of preferred and alternative embodiments, the invention is not intended to be so limited.

1. A method of predicting the performance of an Internet advertising campaign comprising:
collecting anonymous web-surfing data during the serving of Internet advertisements to determine a frequency characteristic of user visits for a set of web sites on which advertising is to be served;
collecting data about user population size for the web sites;
selecting a number of impressions to be served at each web site;
calculating a gross rating point ratio by dividing the number of impressions by the number of total users in the market;
calculating a reach value estimating the number of users expected to be reached by an advertisement.

2. The method of claim 1 including calculating a targeted rating point ratio by dividing the number of impressions by the number of total users in a limited demographic market segment.

3. The method of claim 1 including selecting a demographic set to be targeted.

4. The method of claim 1 wherein collecting data about user population size for the web sites includes collecting demographic information for the web sites.

5. The method of claim 4 wherein the demographic information includes at least one characteristic selected from a set of characteristics including: age, sex, income, parental status, and geographic location.

6. The method of claim 1 including collecting data about the duplication of visits among the web sites, such that individual users visiting more than one site are not counted as separate users.

7. The method of claim 1 wherein determining a frequency distribution includes determining what number of impressions must be served to reach a selected number of users.

8. The method of claim 1 wherein determining a frequency distribution includes determining a propensity to saturation based on the number of visits to the site by a typical user in a selected time interval.

9. The method of claim 1 wherein determining a frequency distribution includes determining a propensity to saturation based on the number of visitors to the site during a selected time interval.

10. The method of claim 1 wherein determining a frequency characteristic includes grouping users into subgroups based on the percentage of impressions served to each subgroup, then simulating the service of a selected number of simulated advertisements by randomly assigning each simulated advertisement to a user.

11. The method of claim 10 wherein randomly assigning each simulated advertisement includes assigning each advertisement to a subgroup by a weighting function of the percentage of impressions served to that subgroup.

12. The method of claim 11 including randomly assigning a simulated advertisement to a user member of the subgroup to which the simulated advertisement was served.

13. The method of claim 10 wherein calculating a reach value includes determining the number of users to which at least a selected number of simulated advertisements were served.

14. The method of claim 10 wherein there are M users are grouped into N subgroups, wherein the first subgroup includes the M/N users to whom the most impressions were served, and each subsequent subgroup includes the M/N users to whom the most impressions were served of the remaining users.

15. The method of claim 10 including proportionally allocating the total number of simulated advertisements to be served to the subgroups based on the number of impressions served to that subgroup.

16. A method of predicting the performance of an Internet advertising campaign comprising:
collecting anonymous web-surfing data during the serving of past Internet advertisements to determine the number of impressions served to each user visiting a selected site during a selected interval;
grouping the users into subgroups based on the percentage of impressions served to each subgroup;
simulating the service of a selected number of simulated advertisements by randomly assigning each simulated advertisement to a user based on the number of impressions served; and
calculating a projected reach value by determining the number of users to which at least a selected number of simulated advertisements were served.

17. The method of claim 16 wherein randomly assigning each simulated advertisement includes assigning each advertisement to a subgroup by a weighting function of the percentage of impressions served to that subgroup.

18. The method of claim 17 including randomly assigning a simulated advertisement to a user member of the subgroup to which the simulated advertisement was served.

19. The method of claim 16 wherein there are M users are grouped into N subgroups, wherein the first subgroup includes the M/N users to whom the most impressions were served, and each subsequent subgroup includes the M/N users to whom the most impressions were served of the remaining users.

20. The method of claim 16 including proportionally allocating the total number of simulated advertisements to be served to the subgroups based on the number of impressions served to that subgroup.

21. The method of claim 16 including determining a target reach by limiting the users to a selected demographic subgroup of the users.
